(19) United States
(12) Patent Application Publication
(10) Pub. No.: US 2012/0153721 A1
(43) Pub. Date: Jun. 21, 2012

(54) UNINTERRUPTED POWER SUPPLY CIRCUIT UNIT AND METHOD FOR UNINTERRUPTED POWER SUPPLY OF CONSUMERS OF A POWER GENERATION PLANT

(75) Inventor: LORENZ FEDDERSEN, Flensburg (DE)

(73) Assignee: FECON GMBH, Flensburg (DE)

(21) Appl. No.: 13/331,804

(22) Filed: Dec. 20, 2011

(30) Foreign Application Priority Data
Dec. 20, 2010 (EP) 10 015 825.2

(51) Int. Cl. H02J 9/00

(52) U.S. Cl. 307/23

(57) ABSTRACT

An uninterrupted power supply (UPS) circuit unit for uninterrupted power supply of consumers of a power generation plant for feeding current into a power network, including an inductance element, in particular a transformer and/or a choke, and a first UPS control circuit which is connected to the inductance element and comprises a DC power path which is connected to a DC power source, wherein the first UPS control circuit is adapted to guarantee uninterrupted power supply of the consumers from the DC power source via the DC power path in the event of a voltage drop in the power network, wherein the UPS circuit unit comprises at least one further independent UPS control circuit connected to the inductance element, arranged parallel to the first UPS control circuit and having a further DC power path which is connected to a DC power source.

### RELATED APPLICATION

The application claims priority under 35 U.S.C. §119(e) of European Patent Application No. 10 015 825.2, filed on Dec. 20, 2010, which is hereby incorporated by reference in its entirety.

### BACKGROUND OF INVENTION

Power generation plants, like for example wind power plants, water power plants, photovoltaic plants or fuel cell plants usually feed the generated current into an external power network via an inverter circuit or a frequency converter circuit. A frequency converter for a wind energy plant is known for example from WO 03 065 567 A1. Such power generation plants comprise current consumers which during normal operation draw their current from the inverters or the frequency converters. For example, the pitch control of a wind energy plant includes electric motors with a power consumption of for example 20 kW to 30 kW. In addition, processors, ventilating fans, communication devices, sensor elements, hydraulic pumps, aggregates and other technical devices consume current. As these often arc essential for the operation and the safety of the power generation plant, a failure of these current-consuming components must be avoided as far as possible.

For this purpose, an uninterrupted power supply system of a wind energy plant is known from EP 1 965 487 A1. In the event of a supply voltage drop for consumers of the wind energy plant, a remaining residual voltage in the circuit of at least 15% of the nominal voltage can be used for supplying the consumers with current. However, it is disadvantageous that the uninterrupted power supply system needs to be over-dimensioned in order that sufficient power can be obtained from the residual voltage.

EP 1 796 254 A2 discloses a power converter system in particular for feeding current from a wind turbine into a power network via a transformer. The power converter system uses a plurality of parallel-connected power converter bridges which are actuated simultaneously in an interleaved manner. Each power converter bridge includes a choke circuit on the input side, a rectifier, an intermediate circuit, an inverter and a choke circuit on the output side. The additional choke circuits which are required for the interleaved operation of the power converters lead to a significant cost increase of the power converter system.

EP 1 763 126 A1 discloses a method for emergency power supply of a pitch control unit of a wind energy plant, in which the pitch control unit is supplied with current from a battery pack in the event of a breakdown of the power supply.

DE 10 2006 024 594 A1 discloses an apparatus for the AC voltage supply of a ship from a supply network in the harbor. In one embodiment, several intermediate dc circuits are coupled by connecting the rectifiers and the inverters in parallel, in case one intermediate dc circuit is not sufficient for satisfying the power demand of the ship.

WO 2010 038152 A1 discloses an emergency power supply system.

### BRIEF SUMMARY

Embodiments of the subject invention relate to an uninterrupted power supply (UPS) circuit unit and a method for uninterrupted power supply of consumers of a power generation plant.

### BRIEF DESCRIPTION OF DRAWINGS

FIG. 1 shows a schematic illustration of a circuit arrangement in a first embodiment.

FIG. 2 shows a schematic illustration of a circuit arrangement in a second embodiment.

FIG. 3 shows a schematic illustration of a circuit arrangement in a third embodiment.

### DETAILED DISCLOSURE

It is an object of embodiments of the present invention to provide an uninterrupted power supply (UPS) circuit unit and a method for uninterrupted power supply for a power generation plant which. Specific embodiments are fail-proof and cost-effective.

Specific embodiments of the invention solve this object with a UPS circuit unit for uninterrupted power supply of consumers of a power generation plant for feeding current into a power network, including an inductance element, in particular a transformer and/or a choke, and a first UPS control circuit which is connected to the inductance element and comprises a DC power path which is connected to a DC power source, wherein the first UPS control circuit is adapted to guarantee uninterrupted power supply of the consumers from the DC power source via the DC power path in the event of a voltage drop in the power network, wherein the UPS circuit unit comprises at least one further independent UPS control circuit connected to the inductance element, arranged parallel to the first UPS control circuit and having a further DC power path which is connected to a DC power source, and/or a method for uninterrupted power supply of consumers of a power generation plant for feeding current into a power network, using such a UPS circuit unit, wherein in the event of a voltage drop in the power network the UPS circuit unit is adapted to supply the at least one consumer with current from at least one intermediate circuit capacitor which is supplied by the power generation plant.

A failure redundancy is produced by using two parallel-connected UPS control circuits. As the UPS control circuit is much more sensitive than the inductance element, it is sufficient to design the UPS control circuit as a redundant feature, whereas one common inductance element, in particular one common transformer with integrated choke, or one common choke, can be used in the UPS circuit unit without significantly increasing the risk of failure. By using one common inductance element for all UPS control circuits in the UPS circuit unit the costs can be reduced significantly since the inductance element is a particularly expensive component. According to embodiments of the invention additional inductance elements, in particular transformers and/or chokes, in each UPS control circuit on the output side and/or on the input side can be omitted. Furthermore, a by-pass line as provided in the prior art and a switch for switching to the by-pass line in the event of a breakdown of the UPS control circuit can be omitted according to embodiments of the invention.

Preferably, the DC power source is formed by at least one DC voltage circuit which is supplied by the power generation plant. By utilizing the power from the DC voltage circuit it may no longer be necessary to use an accumulator. However, an accumulator unit may be provided as DC power source(s) alternatively or in addition to a DC voltage circuit supplied by the power generation plant.

Preferably also during normal operation the consumers are supplied by a DC power source via one of the DC power paths. In this manner the power supply of the consumers during normal operation is guaranteed with simple means. A supply from the power network which requires a further rectification is only necessary in case the power generation plant is inactive.

In the following the invention will be described in more detail on the basis of preferred embodiments with reference to the accompanying drawings.

The circuit arrangement 1 includes a frequency converter 3 which feeds the current of a wind energy plant 5 into a power network via an AC voltage transformer 7. The frequency converter 3 includes a rectifier 9, an intermediate de circuit 11 and an inverter 13. Filters 15 are interconnected between the frequency converter 3 and the medium voltage transformer 7. An electronic control device 17, like for example a digital signal processor DSP controls the power feed-in from the wind energy plant 5 via the frequency converter 3 to the medium voltage transformer 7. In case of for example a photovoltaic plant as power generation plant 5, which already generates direct current, a rectifier 9 would not be necessary. In that case the intermediate dc circuit 11 and the inverter 13 would form an inverter circuit.

Alternating current is generated for example by a generator 19 of the wind energy plant 5 driven by wind power by a rotor 21 via a transmission 23. The three phases 18a, 18b, 18c of the alternating current are rectified in the rectifier 9. The intermediate de circuit 11 which is arranged after of the rectifier 9 comprises an intermediate circuit capacitor 25 supplying the input side of the inverter 13. For each phase 18a, 18b, 18c the inverter 13 includes a respective cascade 27a, 27b, 27c each of which comprises two power switches 29, in particular power transistors, for example IGBTs.

The power switches 29 are controlled using the electronic control device 17 in particular by means of pulse-width modulation control. The supply voltages are measured on the AC voltage side of the inverter 13, preferably between the filter 15 and the medium voltage transformer 7, and are supplied to the control device 17 as measured voltage signals via corresponding lines 31. The currents on the individual phases 18a, 18b, 18c are measured on the output side of the inverter 13, preferably between the inverter 13 and the filter 15, using corresponding current measuring devices 33 and are supplied to the control device 17 as measured current signals via corresponding lines 35. The control device 17 calculates the set currents from the measured voltages and measured currents. On the basis of the set currents and the measured currents the control device 17 determines the control signals for the power switches 29 and controls them accordingly.

The converted three-phase current is smoothed on the output side of the inverter 13 using the filter 15 and may then be transformed to a desired voltage using the AC voltage transformer 7. The filter 15 can be designed as a choke or as a transformer. The AC voltage transformer 7 may be suitably chosen depending on the application. For feeding current into a medium voltage network the transformer 7 is designed for example as a DY medium voltage transformer.

The wind energy plant 5 comprises a control device 39 for the pitch control of the blades of the rotor 21. The power demand of the control device 39 for the pitch control may temporarily amount to for example 20 to 30 kW. The wind energy plant 5 comprises further consumers, for example a transmission control 43, sensor technology, processors, pumps etc.

The consumers 39, 43 are supplied using a UPS circuit unit 45 for an uninterrupted power supply. The UPS circuit unit 45 comprises a transformer 49, preferably with integrated choke and two parallel-connected UPS control circuits 51a, 51b. In addition to the transformer 49, instead of the transformer 49, or instead of the choke which is integrated in the transformer 49, a choke may be provided as a separate component.

The UPS control circuits 51a, 51b preferably are designed as double conversion UPS or online UPS or continuous operation UPS or VFI (voltage and frequency independent) UPS. Each UPS control circuit 51a, 51b preferably comprises one rectifier 53a respectively 53b and one inverter 55a respectively 55b, thus forming a frequency converter. In another embodiment which will be described in more detail below only inverters 55a, 55b are provided and the rectifiers 53a, 53b can be omitted.

The inverters 55a and 55b, respectively, are preferably designed in analogy to the inverter 13, i.e. each inverter 55a, 55b for each phase includes a respective cascade each of which comprises two power switches, in particular power transistors, for example IGBTs, which preferably are controlled by means of pulse-width modulation. The rectifiers 53a and 53b, respectively, are preferably designed in analogy to the rectifier 9. Additional inductance elements, in particular transformers and/or chokes, arc not provided in the UPS control circuits 51a, 51b. The inverters 55a, 55b and, where applicable, the rectifiers 53a, 53b can each be controlled by the control device 17 via control connections 57. In an alternative embodiment not shown, the power converters 55a, 55b and 53a, 53b, respectively, may also he controlled via an internal control device in the UPS circuit unit 45.

The rectifier 53a respectively 53b is connected to an AC voltage input 58 of the UPS circuit unit 45 on the input side, and to the corresponding inverter 55a respectively 55b on the output side. The AC voltage input 58 is connected to one or more phases on the AC voltage output side of the frequency converter 3 via a line 47 or is connected to the power network via the transformer 7. Therefore, it is possible to supply the consumers 39, 43 from the power network via the AC voltage input 58 and the line 47. This preferably is effected only when the power available in the intermediate dc circuit 11 is not sufficient, in particular when starting up the wind energy plant 5.

The UPS circuit unit 45 preferably comprises at least one DC voltage input 56 which, on the one hand, is connected to the DC voltage side of the inverters 55a, 55b and, on the other hand, is connected to the intermediate dc circuit 11. According to this particularly advantageous aspect, a DC power source 26 for the operation of the consumers 39, 43 is formed by the capacitor 25 in the intermediate dc circuit 11.

Alternatively or additionally, a DC power source may he arranged in the UPS circuit unit 45, for example an accumulator unit. In this case, the DC voltage input 56 can be omitted. Generally, one accumulator unit is sufficient for the UPS circuit unit 45, independent of the number of UPS control circuits 51a, 51b arranged therein. In this case the UPS control circuits 51a, 51b advantageously make use of the same accumulator unit.

During normal operation the consumers 39, 43 advantageously draw their current from the DC power source 26, in particular via the DC voltage input 56 from the intermediate dc circuit 11 or the capacitor 25 arranged therein. This provides the advantage that the rectifiers 53a, 53b are inactive during normal operation and thus are not subject to wear. In an alternative embodiment, the consumers 39, 43 during normal operation may draw their current from the power network via the AC voltage input 58.

Preferably only one of the UPS control circuits 51a or 51b is active at a time. I.e. the control device 17 at any time actuates the power converters 55a (where applicable 53a as well) respectively 55b (where applicable 53b as well) of one UPS control circuit 51a respectively 51b only, in order to generate a supply current by the use of the corresponding UPS control circuit 51a respectively 51b. The corresponding inverter 55a respectively 55b thus permanently is subject to the full operating current. The other UPS control circuit 51b respectively 51a preferably is not active during normal operation, i.e. no current is flowing via the respective inverter 55b respectively 55a. This provides the advantage that the power converter 55b (where applicable 53b as well) respectively 55a (where applicable 53a as well) of the inactive UPS control circuit 51b respectively 51a is not subject to wear.

In the event of a network failure or a voltage drop on a phase of the inverter 13 on the network side the inverter 55a respectively 55b of the active UPS control circuit 51a respectively 51b still draws direct current from the intermediate circuit 11 via the DC voltage input 56 in order to guarantee an uninterrupted power supply of the consumers 39, 43. A direct dependency of the supply of the consumers 39, 43 on the power network does thus not exist. As the power for operating the consumers 39, 43 ultimately originates from the generator 19, the wind energy plant 5 can stay operational even in the event of a longer power network breakdown as long as there is sufficient wind. Therefore, the capacity and thus the emergency operation period is not limited as is the case with conventional accumulator units.

In the event of a failure, an internal error or an overload of one of the UPS control circuits 51a, 51b the defective UPS control circuit 51a, 51b is deactivated and the other UPS control circuit 51b, 51a is activated in order to maintain the uninterrupted power supply of the consumers 39, 43. The switching from a defective UPS control circuit 51a, 51b to an intact UPS control circuit 51b, 51a can be effected either by an internal control in the UPS control circuits 51a, 51b or by the central control device 17. In order to maintain the full power demand of all consumers 39, 43 in the event of a defective UPS control circuit 51a, 51b, each UPS control circuit 51a, 51b on its own is dimensioned adequately to provide a power that corresponds to the maximum power consumption of all consumers 39, 43.

In an embodiment not shown the rectifiers 53a, 53b can be omitted. In this case the diodes of the cascades 27a, 27b, 27c are used as rectifiers for starting up the wind energy plant 5. By suitably connecting these diodes the intermediate dc circuit 11 or the DC power input 56 can then be supplied from the power network.

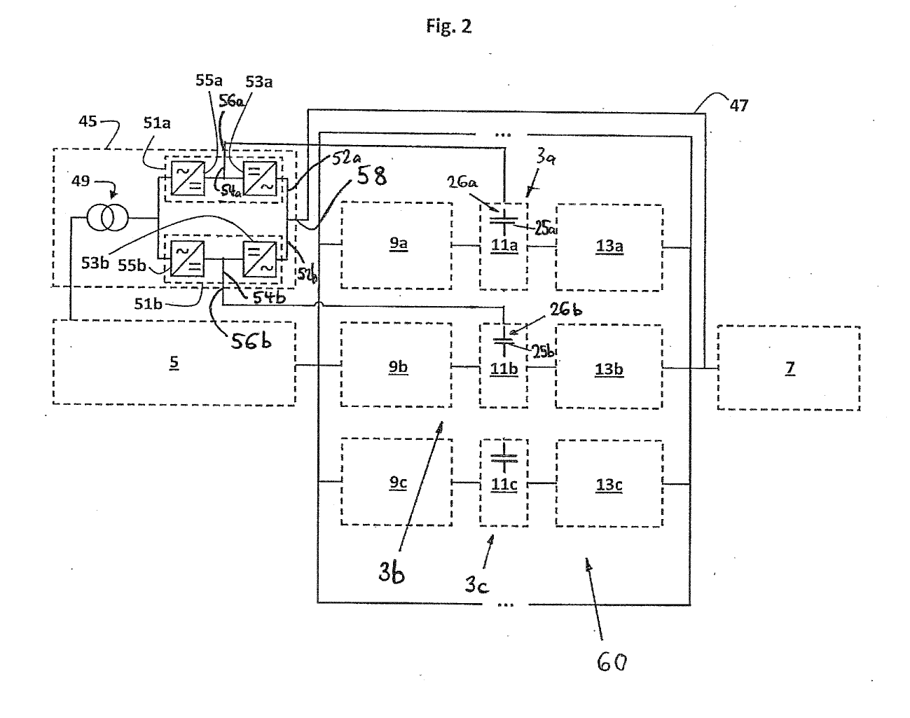

In the embodiment according to FIG. 2 the wind energy plant 5, the frequency converter circuit 60 and the AC voltage transformer 7 are only illustrated schematically. The frequency converter circuit 60 preferably comprises a plurality of parallel-connected frequency converters 3a, 3b, 3c, . In order to further increase the failure safety the UPS circuit unit 45 preferably comprises a plurality of DC voltage inputs 56a, 56b. Each inverter 55a respectively 55b is preferably connected to a different intermediate circuit 11a respectively llb via an allocated DC voltage input 56a, 56b, as is shown for example in FIG. 2, in order to further increase the independency of the UPS control circuits 51a, 51b and thus the failure safety. In a not shown embodiment also one DC voltage input 56 may be connected to a plurality of intermediate circuits 11a, 11b (11c).

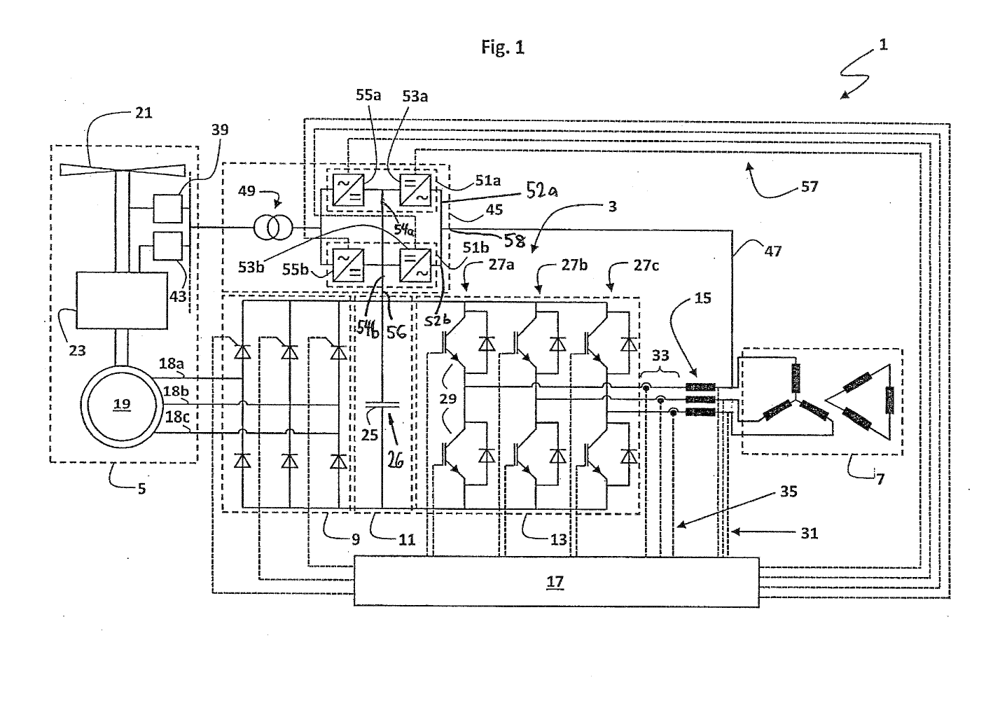

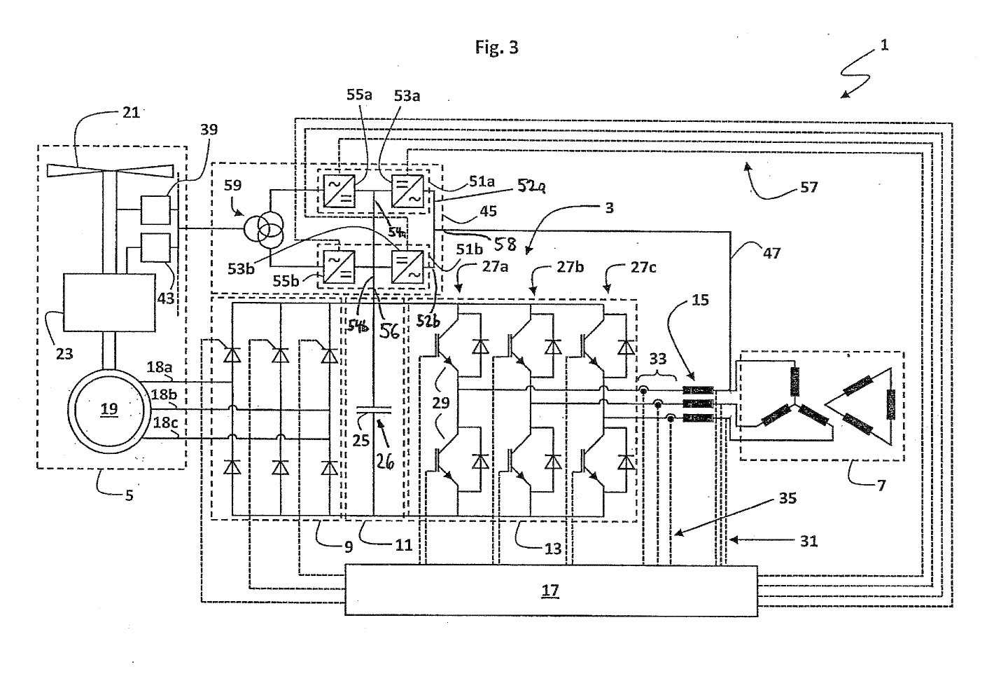

The embodiment of the circuit arrangement 1 shown in FIG. 3 differs from the embodiment shown in FIG. 1 in that the UPS circuit unit 45 for an uninterrupted power supply comprises a three-winding transformer 59, with a first winding on the primary side of the three-winding transformer 59 being connected to a first 51a of the two UPS control circuits 51a, 51b, and a second winding on the primary side of the three-winding transformer 59 being connected to a second 51b of the two UPS control circuits 51a, 51b. Analogically, of course also the embodiment according to FIG. 2 may be equipped with a three-winding transformer 59.

In further embodiments not shown, the UPS circuit unit 45 may comprise more than two parallel-connected UPS control circuits 51a, 51b, 51c ( . . . ).

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. An uninterrupted power supply (UPS) circuit unit for uninterrupted power supply of at least one consumer of a power generation plant for feeding current into a power network, comprising:
an inductance element; and
a first UPS control circuit connected to the inductance element, wherein the first UPS control circuit comprises a first DC power path connected to a DC power source, wherein the first UPS control circuit is adapted to provide uninterrupted power supply of at least one consumer of a power generation plant for feeding power into a power network, wherein the first UPS control circuit is adapted to provide uninterrupted power supply of the at least one consumer from the DC power source via the first DC power path in the event of a voltage drop in the power network,
wherein the UPS circuit unit further comprises at least one additional UPS control circuit having a corresponding at least one additional DC power path, wherein each of the at least one additional UPS control circuit is connected to the inductance element; is independent of, and arranged parallel to, the first UPS control circuit; and is connected to the DC power source via the corresponding DC power path of the corresponding at least one additional DC power path.

2. The UPS circuit unit according to claim 1, wherein the inductance element comprises a transformer.

3. The UPS circuit unit according to claim 2, wherein the inductance element further comprises a choke.

4. The UPS circuit unit according to claim 1, wherein the inductance element comprises a choke.

5. The UPS circuit unit according to claim 1, wherein the DC power source is formed by at least one DC voltage circuit, wherein the at least one DC voltage circuit is supplied power by the power generation plant.

6. The UPS circuit unit according to claim 1, wherein during normal operation the power supply of the at least one consumer is provided by the DC power source via one of the DC power path and the corresponding at least one additional DC power path.

7. The UPS circuit unit according to claim 6, wherein the at least one consumer can optionally be powered by the power network.

8. The UPS circuit unit according to claim 1, wherein during normal operation the power supply of the at least one consumer is provided by the power network via an AC voltage input.

9. The UPS circuit unit according to claim 1, wherein only one of the first UPS control circuit and the at least one additional UPS control circuit is active at a time.

10. The UPS circuit unit according to claim 1, wherein upon detection of a malfunction of one of the first UPS control circuit and the at least one additional UPS control circuit, automatic switching to another one of the first UPS control and the at least one additional UPS control circuit is effected.

11. The UPS circuit unit according to claim 1, wherein the first UPS control circuit and the at least one additional UPS control circuit each have an output side and an input side, wherein each output side and input side is free of inductance elements individually allocated to the corresponding first UPS control and the at least one additional UPS control circuit.

12. The UPS circuit unit according to claim 11, wherein each input side and output side is free of transformers and/or choke individually allocated to the corresponding first UPS control circuit and the at least one additional UPS control circuit.

13. The UPS circuit unit according to claim 1, wherein each of the first UPS control circuit and the at least one additional UPS control circuit is adapted to provide on its own a maximum power consumption of all of the at least one consumer.

14. The UPS circuit unit according to claim 1, wherein the first UPS control circuit comprises a first inverter where the at least one additional UPS control circuit comprises a corresponding inverter of a corresponding at least one additional inverter.

15. The UPS circuit unit according to claim 14, wherein the first DC power path is connected to a first DC voltage side of the first inverter, wherein each of the at least one additional DC power path is connected to a corresponding DC voltage side of the corresponding at least one additional inverter.

16. The UPS circuit unit according to claim 1, wherein the first UPS control circuit comprises a first rectifier wherein each of the at least one additional UPS control circuit comprises a corresponding rectifier of a corresponding at least one additional rectifier.

17. The UPS circuit unit according to claim 16, wherein a first AC voltage side of the first rectifier is connected to the power network, wherein a corresponding AC voltage side of corresponding at least one additional AC voltage side of the corresponding at least one additional rectifier is connected to the power network.

18. The UPS circuit unit according to claim 1, wherein the first DC power path and the at least one additional DC power path are connected to at least two parallel-connected intermediate circuits which are supplied by the power generation plant.

19. The UPS circuit unit according to claim 1, wherein each of the first DC power path and the at least one additional DC power path is connected to a different of a plurality of parallel-connected intermediate circuits which are supplied by the power generation plant.

20. A method for uninterrupted power supply of at least one consumer of a power generation plant for feeding current into a power network, comprising:
using a UPS circuit unit according to claim 1 to provide uninterrupted power supply of at least one consumer of a power generation plant for feeding power into a power network, wherein in the event of a voltage drop in the power network the UPS circuit unit is adapted to supply the at least one consumer with current from at least one intermediate circuit capacitor which is supplied by the power generation plant.
